(19) United States
(12) Patent Application Publication
(10) Pub. No.: US 2026/0050758 A1
(43) Pub. Date: Feb. 19, 2026

(54) APPARATUS AND METHOD FOR RADIO FREQUENCY IDENTIFICATION (RFID) COUPLER

(71) Applicant: Hand Held Products, Inc., Charlotte, NC (US)

(72) Inventors: Kailash KASHYAP, Charlotte, NC (US); Pankaj Kumar PANDEY, Charlotte, NC (US); Gulshan KUMAR, Charlotte, NC (US)

(21) Appl. No.: 19/285,656

(22) Filed: Jul. 30, 2025

(30) Foreign Application Priority Data
Aug. 13, 2024 (IN) 202411061311

(51) Int. Cl. G06K 17/00; B41J 3/407; B41J 3/50; G06K 7/10

(52) U.S. Cl. CPC G06K 17/0025; B41J 3/4075; B41J 3/50; G06K 7/10366

(57) ABSTRACT

An apparatus comprising at least one radio frequency identification (RFID) coupler embedded over a printed circuit board (PCB). Further, at least one media sensor is embedded over the same PCB. The at least one PCB with one RFID Coupler and one media sensor is configured to detect at least one media. Further, the at least one RFID coupler is designed as an eye-goggle shaped profile to accommodate the at least one media sensor such that the at least one RFID Coupler and the at least one media sensor are positioned in proximity to the at least one media.

### CROSS-REFERENCE TO RELATED APPLICATIONS

This application claims priority pursuant to 35 U.S.C. 119(a) to Indian Application No. 202411061311, filed Aug. 13, 2024, which application is incorporated herein by reference in its entirety.

### TECHNOLOGICAL FIELD

Example embodiments of the present disclosure relate generally to radio frequency identification (RFID) systems, and more particularly, to an RFID coupler with media sensor for RFID printer (mobile/desktop/industrial/handheld).

### BACKGROUND

In various radio frequency identification (RFID) label printers, a RFID coupler is present that reads RFID labels when placed inside the RFID label printer. The RFID coupler needs to be centered such that the RFID coupler is always aligned to a center of media. As a result, RFID calibration is performed with an inserted media roll to determine the RFID read/write region for the inserted media roll. However, the RFID coupler generates near-field RF signal to excite the RFID labels to perform Read/Write operation. For a media sensor when placed center, when media calibration is performed, a user can determine a start position and a pitch distance of the inserted media roll altogether. In general, due to space constraints in mobile printers, there are challenges regarding placement of the RFID Coupler in conjunction with the media sensor. The compactness of mobile printers forces to place the RFID labels and/or RFID roll in close proximity of the RFID coupler. Further, when there are multiple RFID labels together placed in a single media roll regardless of whether the transponders/labels are passively or actively powered, the RF signal may activate more than one RFID label at a given time that may cause communication interference as each RFID label may transmit reply signals to the RFID coupler at same time. Further, when the RFID coupler and the media sensor when placed separately, a significant amount of space is required to accommodate both the RFID coupler and media sensor internally within the mobile printers that can further increase the size of the mobile printers and thus increases the cost of manufacturing, becomes bulky, effects the design aesthetics etc. Further, the RFID labels have various designs varied based on the distance between targeted & adjacent RFID labels known as pitch distance. As the pitch distance reduces, the chances of exciting all the adjacent transponders/RFID labels increases drastically and thus, there are high chances of the RFID coupler to excite the adjacent RFID label during the read/write operation on a targeted RFID label.

Applicant has identified a number of deficiencies and problems associated with conventional RFID coupler apparatuses. Through applied effort, ingenuity, and innovation, many of these identified problems have been solved by developing solutions that are included in embodiments of the present disclosure, many examples of which are described in detail herein.

### BRIEF SUMMARY

The following presents a simplified summary to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In an example embodiment, an apparatus is disclosed. The apparatus comprises at least one radio frequency identification (RFID) coupler embedded over a printed circuit board (PCB). Further, at least one media sensor is embedded over the same PCB. The at least one PCB with one RFID Coupler and one media sensor is configured to detect at least one media. Further, the at least one RFID coupler is designed as an eye-goggle shaped profile to accommodate the at least one media sensor such that the at least one RFID Coupler and the at least one media sensor are positioned in proximity to the at least one media.

In some embodiments, the at least one media sensor is positioned within the least one RFID coupler. Further, the at least one media sensor is center aligned to the at least one RFID coupler or the at least one RFID Coupler is center to the at least one media sensor.

In some embodiments, the at least one media sensor is positioned within the least one RFID coupler. Further, the at least one media sensor is aligned to one end of the at least one RFID coupler or the at least one media sensor is aligned to other end to the at least one RFID coupler.

In some embodiments, the at least one RFID coupler comprises a first end and a second end spaced apart from each other. In some embodiments, the at least one RFID coupler is fed with a radio frequency (RF) signal from the first end that splits into at least two paths and merges at the center creating a closed loop. Further, it again splits into at least two paths and merges at the second end of the at least one RFID coupler creating another closed loop. Further, the at least two paths of the RF signal correspond to a first path and a second path. The apparatus further comprises at least one resistor coupled to the second end of the at least one RFID coupler. The at least one resistor corresponds to at least a 50-ohm resistor.

In some embodiments, the at least one media corresponds to at least one RFID media label. In some embodiments, the at least one RFID coupler is designed to have an combined overall length of at least two connected loops which is defined by frequency of operation.

In another example embodiment, a method is disclosed. The method comprises the steps of embedding at least one radio frequency identification (RFID) coupler over a printed circuit board (PCB). The method further comprises the step of embedding at least one media sensor over the PCB, wherein the at least one media sensor is configured to detect at least one media. Further, the at least one RFID coupler having as an eye-goggle shaped profile to accommodate the at least one media sensor such that the at least one media sensor is positioned in proximity to the at least one media.

The above summary is provided merely for purposes of summarizing some exemplary embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained within the following detailed description and its accompanying drawings.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1A illustrates a block diagram of an apparatus comprising at least one radio frequency identification (RFID) coupler in combination with at least one media sensor in accordance with an example embodiment of the present disclosure;

FIG. 1B illustrates a printer in accordance with an example embodiment of the present disclosure;

FIG. 2A illustrates a schematic diagram of the RFID coupler accommodated within at least one media sensor in accordance with an example embodiment of the present disclosure;

FIG. 2B illustrates one or more shapes of at least one closed loop of the RFID coupler in accordance with an example embodiment of the present disclosure;

FIG. 2C illustrates one or more dimensions of at least one closed loop of the RFID coupler in accordance with an example embodiment of the present disclosure;

FIG. 3 illustrates an exemplary scenario of the at least one RFID coupler in communication with at least one media, in accordance with an example embodiment of the present disclosure;

FIG. 4 illustrates an exemplary scenario of placement of the at least one RFID coupler and the at least one media sensor in accordance with an example embodiment of the present disclosure;

FIG. 5 illustrates an exemplary scenario of placement of the at least one media sensor inside the at least one RFID coupler in accordance with an example embodiment of the present disclosure;

FIG. 6 illustrates a graphical representation of frequency of operation of the at least one RFID coupler in accordance with an example embodiment of the present disclosure; and

FIG. 7 illustrates a flowchart of a method of combining the at least one media sensor inside the at least one RFID coupler in accordance with an example embodiment of the present disclosure.

### DETAILED DESCRIPTION

Some embodiments will now be described more fully hereinafter with reference to the accompanying drawings, in which some, but not all, embodiments of the present disclosure are shown. Various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration. ” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

In some embodiments, the present invention relates to a RFID coupler with a media sensor for a RFID printer. In one example, the RFID printer corresponds to a mobile printer. The mobile printer used herein is a portable printing device that is configured to print RFID labels and other materials. The mobile printer is compact, lightweight, and battery powered. The mobile printer further comprises the RFID coupler and the at least one media sensor. The RFID coupler is configured to interact with at least one media placed within the mobile printer. Further, the at least one media sensor is configured to detect the at least one media within the mobile printer. The at least one RFID coupler is having an eye-goggle shaped profile to accommodate the at least one media sensor such that the at least one RFID coupler and the at least one media sensor are positioned within proximity of the at least one media. Further, in one example, the at least one media sensor is placed at a center of the at least one RFID coupler.

In one example, the RFID coupler is securely mounted inside the mobile printer and near a media path from where the RFID labels are configured to pass through. Further, the RFID coupler is powered to the mobile printer's power source. The at least one RFID coupler is connected to at least one processor. Further, at least one media including the RFID labels. The RFID labels have embedded RFID tags that are need to be encoded with data. In one example, the RFID labels are fed within the mobile printer in rolls or sheet. The mobile printer has a feed mechanism to advance the RFID labels through the mobile printer. Further, the mobile printer with the help of the at least one processor is configured to synchronize the data that is to be printed on the RFID labels with data to be encoded on the RFID tags, once the at least one media sensor is able to detect presence of the RFID labels.

Further, the mobile printer prints the RFID labels and the at least one RFID coupler simultaneously write data to the RFID tags. Further, the mobile printer comprises a print head. The print head is configured to apply ink or thermal transfer to print desired information on the RFID labels. Simultaneously, the RFID labels passes by the at least one RFID coupler that reads and write the data to the RFID tag. The RFID coupler writes the encoded data onto the RFID tags as the RFID labels moves through an encoding area. Further, at last, the printed and the encoded RFID labels are dispatched from the mobile printer.

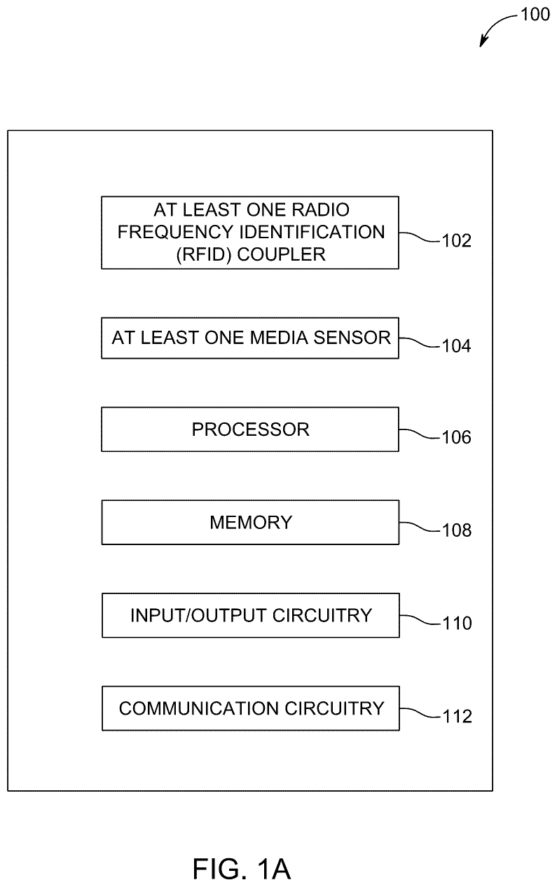

FIG. 1A illustrates a block diagram of an apparatus 100 comprising at least one radio frequency identification (RFID) coupler 102 in combination with at least one media sensor 104, in accordance with an example embodiment of the present disclosure. FIG. 1B illustrates a printer 114, in accordance with an example embodiment of the present disclosure. In some embodiments, the apparatus 100 may comprise the at least one RFID coupler 102, the at least one media sensor 104, at least one processor 106, a memory 108, an input/output circuity 110, and a communication circuitry 112.

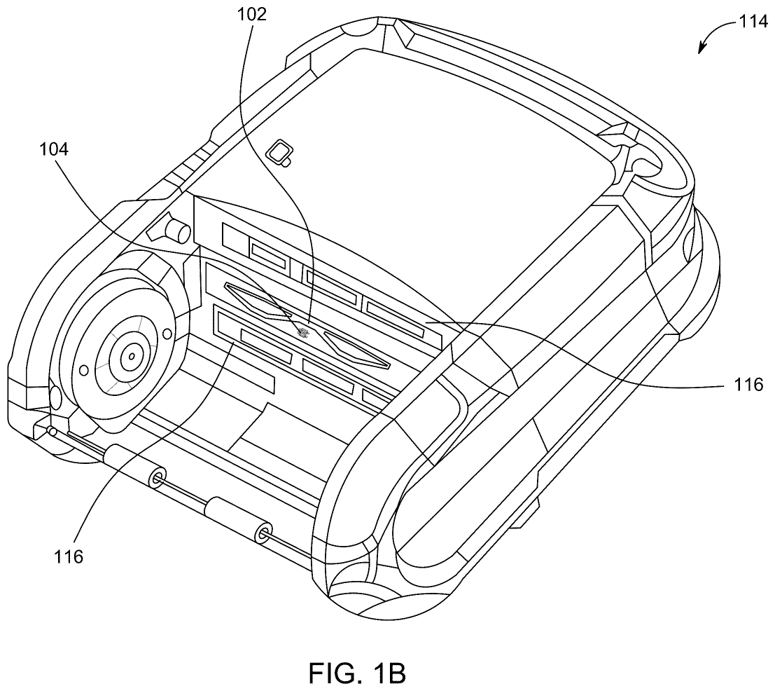

In some embodiments, the at least one RFID coupler 102 may be embedded over a printed circuit board (PCB) (not shown). Further, the at least one RFID coupler 102 may be constructed in an eye-goggle shaped profile, such as illustrated in FIG. 2. In some embodiments, the at least one media sensor 104 may be embedded over the PCB. The at least one media sensor 104 may be configured to detect at least one media (not shown). In some embodiments, the at least one media may correspond to at least one RFID media label. In some embodiments, the at least one RFID coupler 102 having the eye-goggle shaped profile to accommodate the at least one media sensor 104 such that the at least one RFID coupler and the at least one media sensor 104 are positioned within proximity of the at least one media. Further, the at least one media sensor 104 may be positioned within the at least one RFID coupler 102 in a printer. The at least one RFID coupler 102 and the at least one media sensor 104 may be embedded over a single PCB which has a copper etch structure in the eye-goggle shaped profile.

In some embodiments, the at least one media sensor 104 may be center aligned to the at least one RFID coupler 102. In some embodiments, the at least one media sensor 104 may be at the center (not shown) of the at least one RFID coupler 102. In some embodiments, the at least one media sensor 104 may correspond to at least one of a gap sensor, a notch sensor, a reflective sensor, a black mark sensor, a die-cut hole sensor, an ultrasonic sensor, a capacitive sensor, an infrared sensor, a RF sensor, a color sensor or any other sensor known in the art. In some embodiments, the at least one RFID coupler 102 along with the at least one media sensor 104 may communicate with the at least one media placed inside the printer.

Further, the apparatus 100 may comprise at least one processor 106. The at least one processor 106 may be configured to receive information of the detected at least one media. The at least one processor 106 may be configured to analyze the received information of the detected at least one media. The at least one processor 106 may be configured to determine whether the at least one media sensor 104 is positioned within proximity of the at least one media, based at least on the received information. In some embodiments, the at least one media may correspond to at least one RFID media label with an integrated circuit (IC). In some embodiments, the at least one processor 106 may include suitable logic, circuitry, and/or interfaces that are operable to execute one or more instructions stored in the memory 108 to perform predetermined operations. In one embodiment, the at least one processor 106 may be configured to decode and execute any instructions received from one or more other electronic devices or server(s). The at least one processor 106 may be configured to execute one or more computer-readable program instructions, such as program instructions to carry out any of the functions described in this description. Further, the processor may be implemented using one or more processor technologies known in the art. Examples of the processor include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

Further, the memory 108 may be communicatively coupled to the at least one processor 106. Further, the memory 108 may be configured to store a set of instructions and data executed by the one or more processors 106. Further, the memory 108 may include the one or more instructions that are executable by the one or more processors 106 to perform specific operations. In some embodiments, the memory 108 may be configured to include one or more instructions to receive information of the detected at least one media. Further, the memory 108 may be configured to include one or more instructions to analyze the received information of the detected at least one media. Further, the memory 108 may be configured to include one or more instructions to determine whether the at least one media sensor 104 is positioned within proximity of the at least one media, based at least on the analysis. It is apparent to a skilled artisan that the one or more instructions stored in the memory 108 enable the apparatus 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the apparatus 100 may further comprise the input/output circuitry 110. The input/output circuitry 110 may enable a user to communicate or interface with the printer via an interface (not shown). The interface may include N number of user devices (not shown). It may be noted that the input/output circuitry 110 may act as a medium to transmit input from the interface to and from the apparatus 100. In some embodiments, the input/output circuitry 110 may refer to the hardware and software components that facilitate the exchange of information between the user and the apparatus 100. In one example, the apparatus 100 may include a graphical user interface (GUI) (not shown) as input circuitry to allow the user to input data. The input/output circuitry 110 may include various input devices such as keyboards, barcode scanners, GUI for the user to provide data and various output devices such as displays, printers for the user to receive data. In another example, the input/output circuitry 110 may include various output circuitry such as indicators to indicate the correct and incorrect placement of the at least one media sensor 104.

In some embodiments, the apparatus 100 may further comprise the communication circuitry 112. The communication circuitry 112 may allow the at least one RFID coupler 102 and the at least one media sensor 104 to exchange data or information with other systems or apparatuses. Further, the communication circuitry 112 may include network interfaces, protocols, and software modules responsible for sending and receiving data or information. In some embodiments, the communication circuitry 112 may include Ethernet ports, Wi-Fi adapters, or communication protocols like HTTP or MQTT for connecting with other systems. The communication circuitry 112 may allow the apparatus 100 to stay up-to-date and accurately track the placement of the at least one media sensor 104.

In some embodiments, the apparatus 100 may be referred to as a printer 114, as illustrated in FIG. 1B. The printer 114 may correspond to the apparatus 100. The printer 114 may comprise the at least one RFID coupler 102 and the at least one media sensor 104. Further, the printer 114 may comprise adjacent at least one media 116. The adjacent at least one media 116 may be placed adjacent to the at least one RFID coupler 102, i.e., either above or below the at least one RFID coupler 102. Further, the at least one media sensor 104 may be placed along one or more sides of the at least one RFID coupler 102. The at least one media sensor 104 may be placed as long as the adjacent at least one media 116 is positioned in the proximity of the at least one media sensor 104 range. Further, the at least one RFID coupler 102 may excite the adjacent at least one media 116 during the read/write operation on the at least one media.

It will be apparent to one skilled in the art the above-mentioned components of the apparatus 100 have been provided only for illustration purposes, without departing from the scope of the disclosure.

FIG. 2A illustrates a schematic diagram of the at least one RFID coupler 102 accommodated within the at least one media sensor 104 in accordance with an example embodiment of the present disclosure. FIG. 2B illustrates one or more shapes of at least one closed loop of the RFID coupler in accordance with an example embodiment of the present disclosure. FIG. 2C illustrates one or more dimensions of at least one closed loop of the RFID coupler in accordance with an example embodiment of the present disclosure.

In some embodiments, the apparatus 100 may comprise the at least one RFID coupler 102, and at least one media sensor 104. The at least one RFID coupler 102 may be embedded over a printed circuit board (PCB) 200. Further, the at least one media sensor 104 may be embedded over the PCB 200. In some embodiments, the PCB 200 may include one or more dimensions. In one example embodiment, the PCB 200 may include a dimension of 100×10×1.6 millimeter (mm).

Further, the at least one RFID coupler 102 may comprise a first end 202 and a second end 204 spaced apart from each other. In some embodiments, the at least one RFID coupler 102 may be fed with a radio frequency (RF) signal from the first end 202 that splits into at least two paths. Further, the at least two paths of the RF signal may correspond to a first path 206 and a second path 208. In one example embodiment, the first path 206 and the second path 208 may be of varying width. In another example embodiment, the first path 206 and the second path 208 may be of same width. Thereafter, the RF signal split into the at least two paths may merge at the second end 204 of the at least one RFID coupler 102.

In some embodiments, the first path 206 and the second path 208 of the at least one RFID coupler 102 may merge together at center 210 to form the eye-goggled shaped profile of the at least one RFID coupler 102. The first end 202 to the first path 206 and the second path 208 may diverge and then merge at the center 210 forming a closed loop 212. Further, from the center 210, the first path 206 and the second path 208 may diverge and then merge at the second end 204, to form another closed loop 214, and thus forming the eye-google shaped profile of the at least one RFID coupler 102. As a result, the eye-goggled shaped profile of the at least one RFID coupler 102 may form at least two loops, i.e., the closed loop 212 and the another closed loop 214, comprising the first path 206 and the second path 208.

In some embodiments, the closed loop 212 of the at least two loops may be formed when the first path 206 and the second path 208 diverge from the first end 202 and then, merge together at center 210. Further, the another closed loop 214 of the at least two loops may be formed when the first path 206 and the second path 208 diverge from the center 210 and then, merge together at the second end 204. The at least one RFID coupler 102 may be fabricated to have a plurality of varying lengths for the closed loop 212 and the another closed loop 214 of the at least two loops. Further, an overall length of the at least one RFID coupler 102 may be a size decision factor for the closed loop 212 and the another closed loop 214 of the at least two loops of the at least one RFID coupler 102. Each of the at least two loops may have a varying length that depends on the placement of the at least one RFID coupler 102 inside the printer. Further, the overall length of the at least one RFID coupler 102 may be same even when the at least two loops may have the varying length.

In some embodiments, a total area occupied by the at least two loops of the at least one RFID coupler 102 may be defined. The total area occupied by the at least two loops of the at least one RFID coupler 102 may correspond to a sum of an area occupied by the closed loop 212, an area occupied by the another closed loop 214, and an area occupied by the at least one media sensor 102. The total area occupied by the at least two loops of the at least one RFID coupler 102 may be calculated using a formula (1)

Area occupied by the closed loop 212+area occupied by the another closed loop 214+area occupied by the at least one media sensor 104=total area occupied by at least one RFID coupler 102 (1)

In some embodiments, a minimum loop area may be defined for the at least two loops of the at least one RFID coupler 102. The minimum loop area may correspond to the area occupied by the at least one media sensor 104. Further, a maximum loop area may be defined for the at least two loops of the at least one RFID coupler 102. The maximum loop area may correspond to a difference of overall area occupied by the at least one RFID coupler 102 and the area occupied by the at least one media sensor 104. The maximum loop area may be calculated using a formula (2)

Maximum loop area=total area occupied by the at least one RFID coupler 102−area occupied by the at least one media sensor 104 (2)

In some embodiments, a width of each of the at least two loops of the at least one RFID coupler 102 may be varied. The width of each of the at least two loops may be dependent on the area occupied by each of the at least two loops. The width of each of the at least two loops may be varied from 1 mm till a custom value. The width of each of the at least two loops may be varied such that an overall input impedance (Zi) of the at least one RFID coupler 102 is equal to 50 ohms (Ω).

Referring to FIG. 2B, the closed loop 212 and the another closed loop 214 may be a round or oval shape, as illustrated by 216, or rectangle or square shape, as illustrated by 218, or triangle shape, or a pentagonal shape, as illustrated by 220, or a heptagonal shape, as illustrated by 222, or a hexagonal shape, as illustrated by 224, or any other shape known in the art, forming at least 2 conjunction closed loops on both sides of the center 210, and thus forming the eye-google shaped profile of the at least one RFID coupler 102.

Further, the apparatus 100 may comprise at least one resistor (not shown) coupled to the second end 204 of the at least one RFID coupler 102. The at least one resistor may be configured to match the input impedance from the RF signal while detecting the at least one media. In one example embodiment, the at least one resistor may correspond to at least a 50-ohm resistor. Further, the at least one media may correspond to at least one RFID media label.

In some embodiments, the at least one RFID coupler 102 may be fabricated to have a plurality of at least one closed loop. In some embodiments, the length of the at least one RFID coupler 102 may be varied based at least on required frequency of operation. In some embodiments, the at least one RFID coupler is designed to have at least 2 conjunction loops. The length of loop is defined by frequency of operation and substrate permittivity i.e., λg=300/(f*√εᵣ) where f is frequency of operation, εᵣ is PCB permittivity. In an example, at 910 MHz with FR4 PCB, the first path 206 and the second path 208 has 40 mm length, as illustrated by 226 in FIG. 2C, each forming at least one closed loop length of 80 mm. Further, the overall loop length with at least two conjunction closed loops may be 160 mm. The frequency of operation of the at least one RFID coupler may be varied based at least on an operating frequency of 860-960 MHz, 2.45 gigahertz (GHz), or 5.8 GHz. Further, the at least one RFID coupler 102 may comprise at least one of an inductive coupler, a capacitive coupler, a microstrip coupler, a near-field coupler, or any other coupler known in the art.

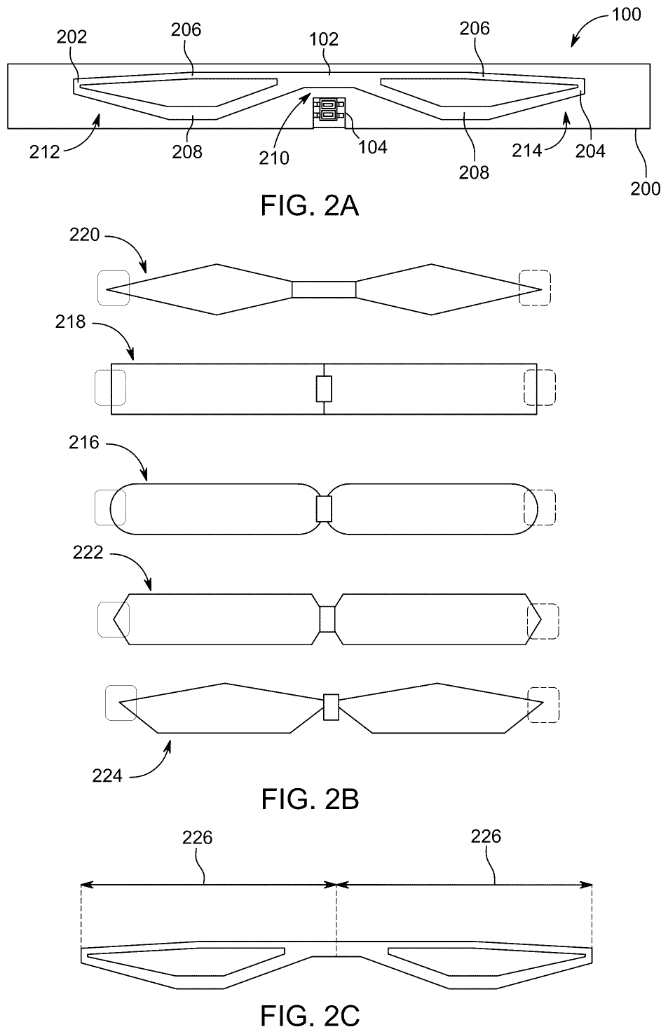

FIG. 3 illustrates an exemplary scenario 300 of the at least one RFID coupler 102 in communication with at least one media 302, in accordance with an example embodiment of the present disclosure.

The at least one RFID coupler 102 may accommodate the at least one media sensor 104 such that the at least one media sensor 104 is positioned in proximity to the at least one media 302. Further, the at least one RFID coupler 102 may communicate with the at least one media 302 positioned in the proximity of the at least one media sensor 104 inside the printer. While communicating with the at least one media 302, the adjacent at least one media 304 may not be targeted by the at least one RFID coupler 102 for communication. In one example, the adjacent at least one media 304 may correspond to the adjacent at least one media 116, as shown in FIG. 1B. In various embodiments, the at least one media 302 may be targeted by the at least one RFID coupler 102 to communicate with the adjacent at least one media 304.

Further, the at least one RFID coupler 102 may communicate with the at least one media 302 using a magnetic field 306. The magnetic field 306 may be generated by the at least one RFID coupler 102. Further, the at least one media 302 may capture energy from the generated magnetic field 306. The at least one media 302 captures the energy to exchange data with the at least one RFID coupler 102 by using the captured energy. Further, the generated energy 306 may be modulated by the at least one media 302 for encoding data in the magnetic field that may be read or decoded by the RFID coupler 102. Thereafter, subsequent exchange of data may be completed between the at least one RFID coupler 102 and the at least one media 302 through modulations in the generated magnetic field 306. In this manner, the RFID coupler 102 may read and/or write data encoded on the at least one media 302.

In some embodiments, during the encoding process, the at least one media 302 may be encoded similarly or may be encoded using one or more individual parameters, in accordance with commands from the at least one RFID coupler 102. In one embodiment, a timing signal for encoding the at least one media 302 as the at least one media passes across the at least one RFID coupler 102 may be generated automatically by the at least one RFID coupler 102 based on speed with which the at least one media 302 travels along the first end 202 and the second end 204. Other methods for individually encoding the at least one media 302 may also be used, without departing from the scope of the disclosure.

As illustrated, the eye-goggle shape of the at least one RFID coupler 102 may facilitate wireless communication along with the at least one media sensor 104, and the at least one media 302 oriented in a variety of different directions because the magnetic field 306 emerging from the at least one RFID coupler 102 may have substantial off-axis components relative to path of the at least one media 302. In some embodiments, the orientation of the first path 206 and the second path 208 may be chosen in order to encode the at least one media 302 by the at least one RFID coupler 102 that is configured to operate in one or another of the operating frequency.

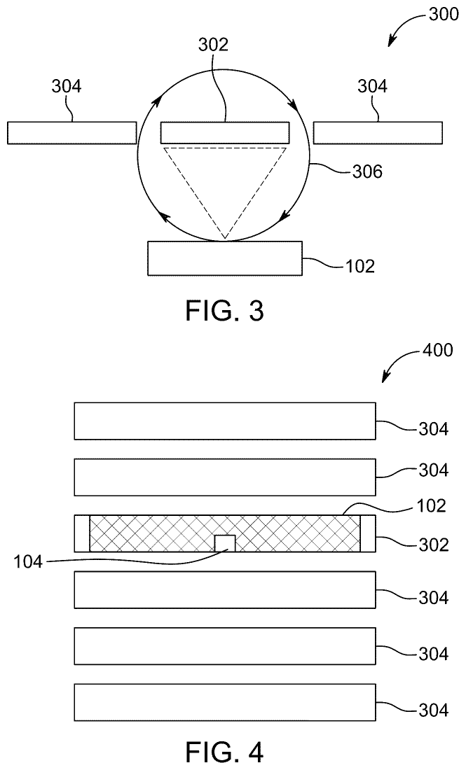

FIG. 4 illustrates an exemplary scenario 400 of placement of the at least one media sensor 104 and the at least one RFID coupler 102 in accordance with an example embodiment of the present disclosure.

As discussed herein, the at least one media sensor 104 may be center aligned to the at least one RFID coupler 102. The at least one media 302 may be targeted by the at least one RFID coupler 102 and one media sensor 104. Further, the one RFID coupler 102 and the at least one media sensor 104 may detect the targeted at least one media 302. Further, the at least one media 302 and the adjacent at least one media 304 may be located at a distance apart from each other, inside the printer. In some embodiments, the distance may correspond to a pitch distance. Further, the at least one media may comprise one or more designs (not shown) based on the pitch distance. In some example embodiments, the pitch distance may start from 0.5 inch, 0.6 inch, 0.8 inch, 1 inch, 1.2 inch, 1.5 inch, 1.8 inch, 2 inch, 2.5 inch or any other pitch distance value known in the art. Further the pitch distance value may increase depending on the user requirement. In some embodiments, as the pitch distance reduces, the possibility of exciting all the adjacent at least one media 304 may increase. Further, there may be high possibility of the at least one RFID coupler 102 to excite the adjacent at least one media 304 during the read/write operation on the at least one media 302.

As discussed above, the at least one RFID coupler 102 may only communicate with the targeted at least one media 302, which is due to the copper etch structure shaped as the eye-goggle shaped profile. Thereafter, the copper etch structure may not degrade the performance of the at least one RFID coupler 102 as the copper etch structure on PCB may place the at least one media sensor 104 in the printer easily.

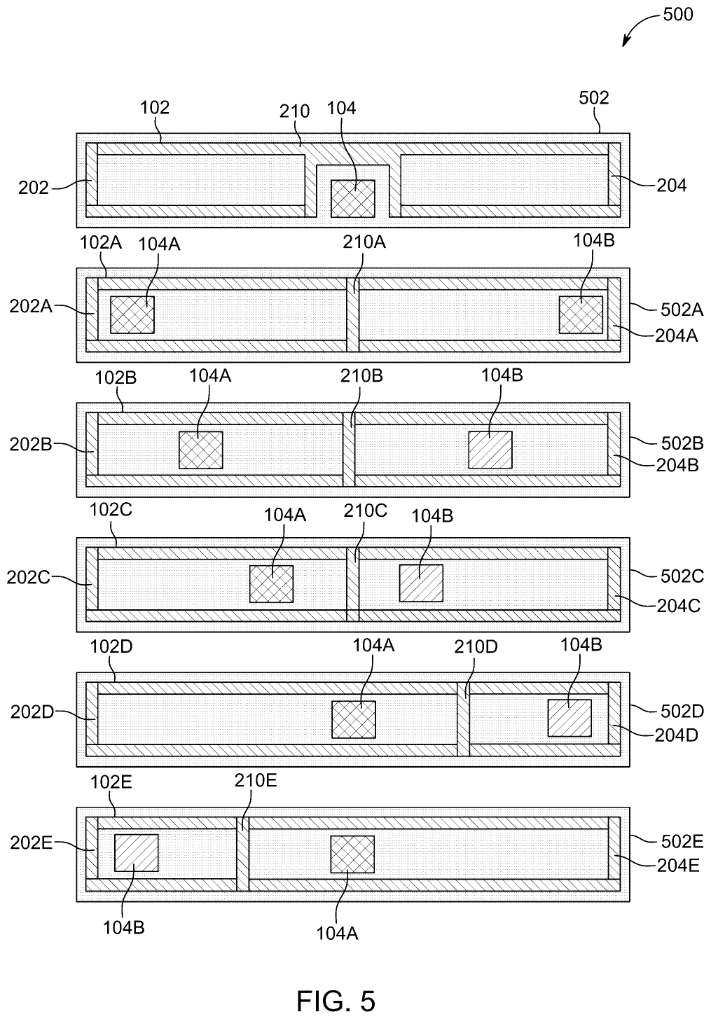

FIG. 5 illustrates an exemplary scenario 500 of placement of the at least one media sensor 104 inside the at least one RFID coupler 102 in accordance with an example embodiment of the present disclosure.

As discussed in FIG. 1, the at least one media sensor 104 may be placed anywhere along one or more sides of the at least one RFID coupler 102. The at least one media sensor 104 may be placed as long as the adjacent at least one media 304 is positioned in the proximity of the at least one media sensor 104 range. Further, both the at least one RFID coupler 102 and the at least one media sensor 104 may be embedded over a PCB 502. In some embodiments, the at least one media sensor 104 may be placed at the center 210, aligned to the at least one RFID coupler 102.

In some embodiments, a first media sensor 104A and a second media sensor 104B may be placed close to a first end 202A and a second end 204A, respectively, of the at least one RFID coupler 102A, having a center 210A, over a PCB 502A. In another example embodiment, the first media sensor 104A and the second media sensor 104B may be placed between a first end 202B and a center 210B, and a second end 204B and the center 210B, respectively, of the at least one RFID coupler 102B over the PCB 502B. In yet another example embodiment, each of the first media sensor 104A and the second media sensor 104B may be placed close to a center 210C, aligned to the at least one RFID coupler 102C, having a first end 202C and a second end 204C, over a PCB 502C.

In yet another example embodiment, the first media sensor 104A may be placed at a center of a PCB 502D. The second media sensor 104B may be placed close to a second end 204D of the PCB 502D. Further, a center 210D aligned to the at least one RFID coupler 102D, having a first end 202A, may be shifted in proximity to the second end 204D in the PCB 502D. In another example embodiment, the first media sensor 104A may be placed at the center of a PCB 502E. The second media sensor 104B may be placed close to a first end 202E of the PCB 502E. Further, a center 210E aligned to the at least one RFID coupler 102E, having a second end 204E, may be shifted in proximity to the first end 202E, in which the second media sensor 104B is placed, in the PCB 502E.

In the example embodiments discussed above, the placement of the first media sensor 104A and the second media sensor 104B relative to the at least one RFID coupler 102, the at least one RFID coupler 102A, the at least one RFID coupler 102B, the at least one RFID coupler 102C, the at least one RFID coupler 102D, and the at least one RFID coupler 102E respectively, may be selected based at least on design requirements and operational considerations of the apparatus 100, without departing from the scope of the disclosure.

In some embodiments, the at least two paths of the at least one RFID coupler 102, the at least one RFID coupler 102A, the at least one RFID coupler 102B, the at least one RFID coupler 102C, the at least one RFID coupler 102D, and the at least one RFID coupler 102E may shift based on the placement of the first media sensor 104A, the second media sensor 104B. Further, based at least on the shifting of the at least two paths, the structure of the at least one RFID coupler 102, the at least one RFID coupler 102A, the at least one RFID coupler 102B, the at least one RFID coupler 102C, the at least one RFID coupler 102D, and the at least one RFID coupler 102E may change while remaining in the eye-goggle shaped profile. Further, change in structure may correspond to the shift in position of the center 210 aligned to the at least one RFID coupler 102 towards the one or more ends in the PCB 502, the PCB 502A, the PCB 502B, the PCB 502C, the PCB 502D, and the PCB 502E.

In some embodiments, the eye-goggled shaped profile of at least one RFID coupler 102, the at least one RFID coupler 102A, the at least one RFID coupler 102B, the at least one RFID coupler 102C, the at least one RFID coupler 102D, and the at least one RFID coupler 102E may form at least two loops in PCB 502, the PCB 502A, the PCB 502B, the PCB 502C, the PCB 502D, and the PCB 502E respectively. The at least one RFID coupler 102, the at least one RFID coupler 102A, the at least one RFID coupler 102B, the at least one RFID coupler 102C, the at least one RFID coupler 102D, and the at least one RFID coupler 102E may be fabricated to have a plurality of varying lengths of each of the at least two loops. Further, overall length of the at least one RFID coupler 102, the at least one RFID coupler 102A, the at least one RFID coupler 102B, the at least one RFID coupler 102C, the at least one RFID coupler 102D, and the at least one RFID coupler 102E may be a size decision factor of each of the at least two loops of the at least one RFID coupler 102, the at least one RFID coupler 102A, the at least one RFID coupler 102B, the at least one RFID coupler 102C, the at least one RFID coupler 102D, and the at least one RFID coupler 102E.

Each of the at least two loops may have a varying length that depends on the placement of the at least one RFID coupler 102, the at least one RFID coupler 102A, the at least one RFID coupler 102B, the at least one RFID coupler 102C, the at least one RFID coupler 102D, or the at least one RFID coupler 102E inside the printer. The overall length of the at least one RFID coupler 102, the at least one RFID coupler 102A, the at least one RFID coupler 102B, the at least one RFID coupler 102C, the at least one RFID coupler 102D, and the at least one RFID coupler 102E may be same even when the at least two loops may have the varying length.

In some embodiments, a total area occupied by the at least two loops of the at least one RFID coupler 102, the at least one RFID coupler 102A, the at least one RFID coupler 102B, the at least one RFID coupler 102C, the at least one RFID coupler 102D, or the at least one RFID coupler 102E may be defined. The total area may correspond to a sum of an area occupied by the at least one RFID coupler 102, the at least one RFID coupler 102A, the at least one RFID coupler 102B, the at least one RFID coupler 102C, the at least one RFID coupler 102D, or the at least one RFID coupler 102E, an area occupied by another loop of the at least two loops in the at least one RFID coupler 102, the at least one RFID coupler 102A, the at least one RFID coupler 102B, the at least one RFID coupler 102C, the at least one RFID coupler 102D, or the at least one RFID coupler 102E, and an area occupied by the at least one media sensor 104, the at least one media sensor 104A, or the at least one media sensor 104B is equal to area occupied by the at least two loops of the at least one RFID coupler 102. The total area occupied by the at least two loops may be calculated using the formula (1).

In some embodiments, a minimum loop area may be defined for the at least two loops of the at least one RFID coupler 102, the at least one RFID coupler 102A, the at least one RFID coupler 102B, the at least one RFID coupler 102C, the at least one RFID coupler 102D, or the at least one RFID coupler 102E. The minimum loop area may correspond to an area occupied by the at least one media sensor 104, the at least one media sensor 104A, or the at least one media sensor 104B respectively. Further, a maximum loop area may be defined for the at least two loops of the at least one RFID coupler 102, the at least one RFID coupler 102A, the at least one RFID coupler 102B, the at least one RFID coupler 102C, the at least one RFID coupler 102D, or the at least one RFID coupler 102E. The maximum loop area may correspond to a difference of overall area of the at least one RFID coupler 102, the at least one RFID coupler 102A, the at least one RFID coupler 102B, the at least one RFID coupler 102C, the at least one RFID coupler 102D, or the at least one RFID coupler 102E, and the area occupied by the at least one media sensor 104, the at least one media sensor 104A, or the at least one media sensor 104B respectively. The maximum loop area may be calculated using the formula (2).

In some embodiments, a width of each of the at least two loops of the at least one RFID coupler 102, the at least one RFID coupler 102A, the at least one RFID coupler 102B, the at least one RFID coupler 102C, the at least one RFID coupler 102D, and the at least one RFID coupler 102E may be varied. The width of each of the at least two loops may be dependent on the area occupied by each of the at least two loops. The width of each of the at least two loops may be varied from 1 mm till a custom value. The width of each of the at least two loops may be varied such that an overall input impedance (Zi) of the at least one RFID coupler 102, the at least one RFID coupler 102A, the at least one RFID coupler 102B, the at least one RFID coupler 102C, the at least one RFID coupler 102D, and the at least one RFID coupler 102E is equal to 50Ω.

Further, it may be noted that the PCB 502A, the PCB 502B, the PCB 502C, the PCB 502D, and the PCB 502E may be similar to the PCB 502, as described above. Further, it may also be noted that the at least one RFID coupler 102, the at least one RFID coupler 102A, the at least one RFID coupler 102B, the at least one RFID coupler 102C, the at least one RFID coupler 102D, and the at least one RFID coupler 102E may hold the same meaning and same functionality within the specification. Further, it may also be noted that the at least one media sensor 104, the first media sensor 104A, and the second media sensor 104B may hold the same meaning and same functionality within the specification.

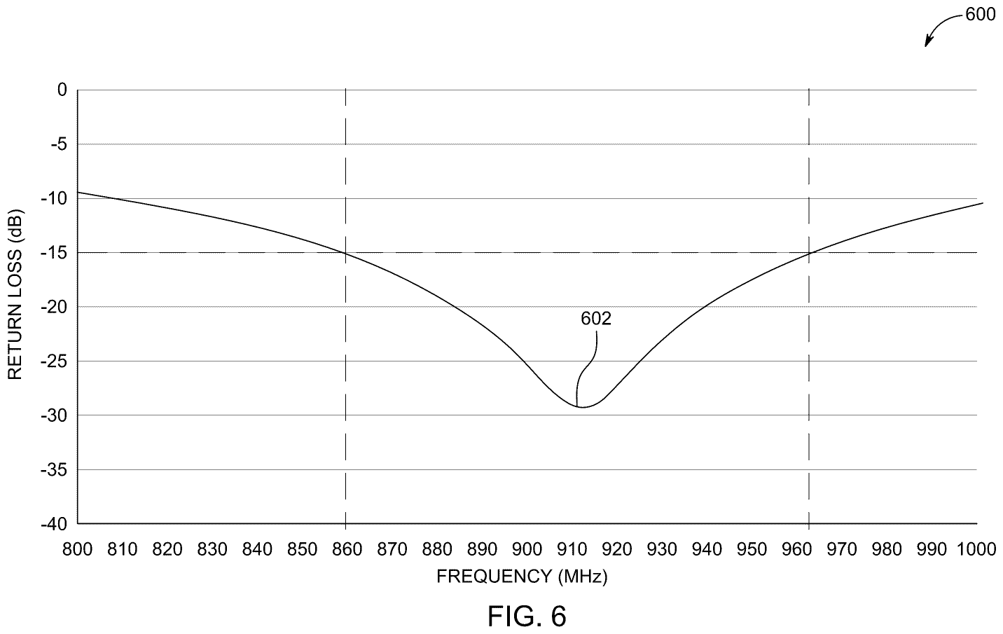

FIG. 6 illustrates a graphical representation 600 of frequency of operation of the at least one RFID coupler in accordance with an example embodiment of the present disclosure.

In some embodiments, the graphical representation 600 may represent the frequency of operation of the at least one RFID coupler 102. The x-axis of the graphical representation 600 may represent the frequency of operation in MHz as “Frequency (MHZ)”. The y-axis of the graphical representation 600 may represent a return loss in decibel (dB) as “Return Loss (dB)” for the frequency of operation, in percentage. The graphical representation 600 may comprise a curve 602 representing the frequency of operation having the return loss. In one example, the graphical representation 600 may comprise a frequency of operation of 910 MHZ for a return loss of −30 dB.

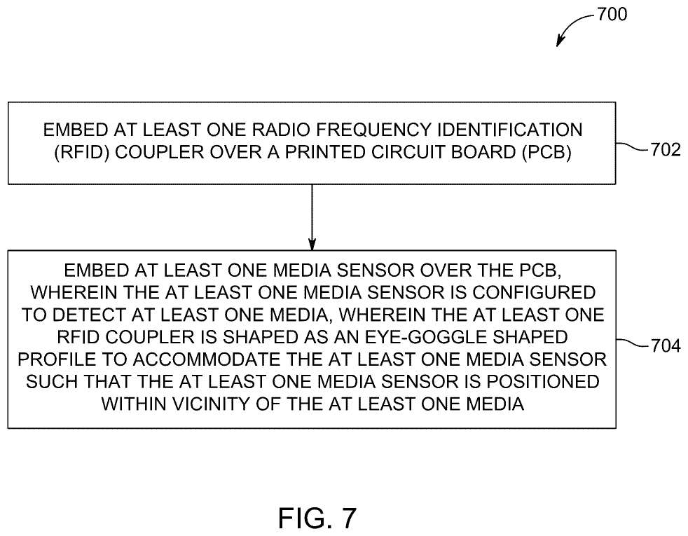

FIG. 7 illustrates a flowchart showing a method 700 of combining the at least one media sensor 104 inside the at least one RFID coupler 102 in accordance with an example embodiment of the present disclosure.

At operation 702, the at least one RFID coupler 102 is embedded over the PCB 200. In some embodiments, the at least one RFID coupler 102 may comprise the first end 202 and the second end 204 spaced apart from each other. Further, the at least one RFID coupler 102 may be fed with the RF signal from the first end 202 that splits into at least two paths and merges at the second end 204 of the at least one RFID coupler 102. In some embodiments, the at least two paths of the RF signal correspond to the first path 206 and the second path 208. Further, the first path 206 and the second path 208 may be of varying width.

At operation 704, the at least one media sensor 104 is embedded over the PCB 200, wherein the at least one media sensor 104 is configured to detect at least one media 302. In some embodiments, the at least one RFID coupler 102 may be shaped as an eye-goggle shaped profile to accommodate the at least one media sensor 104 such that the at least one media sensor 104 is positioned within proximity of the at least one media 302. In some embodiments, the at least one media sensor 104 may be positioned within the least one RFID coupler 102. Further, the at least one RFID coupler 102 along with the at least one media sensor 104, communicates with the at least one media 302 placed inside the printer.

Further, the position of the at least one media sensor 104 may comprise the at least one media sensor center 104 aligned to the at least one RFID coupler 102 or the at least one media sensor 104 offset to the center of the at least one RFID coupler 102.

In some embodiments, at least one resistor may be coupled to the second end 204 of the at least one RFID coupler 102. Further, the at least one resistor may correspond to at least a 50-ohm resistor. In some embodiments, the at least one media may correspond to at least one RFID media label. In some embodiments, the at least one RFID coupler is fabricated to have a length (for example, 80 mm (millimeter)). It will be apparent to one skilled in the art that above-mentioned length of the at least one RFID coupler 102 (for example, 80 mm) has been provided only for illustration purposes, without departing from the scope of the disclosure.

In some embodiments, the disclosed invention may minimize the interference of other components of the printers due to unique eye-goggle shaped structure of the at least one RFID coupler 102. Further, the disclosed invention may ensure proper placement of the at least one media sensor 104, without degrading the performance of the at least one RFID coupler 102. Further, due to the eye-goggle shaped structure, the at least one media sensor 104 may be accommodated inside the at least one RFID coupler 102 and thereby, the total footprint area of the at least one RFID coupler 102 and the at least one media sensor 104 is same. Further, due to the same total footprint area, the at least one RFID coupler 102 and the at least one media sensor 104 may be packed within a confined space of a portable printer.

As will be appreciated by one skilled in the art, aspects of the present disclosure may be embodied as an apparatus, system, method, or computer program product. Accordingly, aspects of various embodiments may take the form of an entirely hardware embodiment, an entirely software embodiment (including firmware, resident software, micro-code, etc.) or an embodiment combining software and hardware aspects that may all generally be referred to herein as a “circuit,” “module”, “system” or “sub-system.” In addition, aspects of the present disclosure may take the form of a computer program product embodied in one or more computer readable medium(s) having computer readable program code embodied thereon.

The foregoing descriptions of specific embodiments have been presented for purposes of illustration and description. They are not intended to be exhaustive or to limit the embodiments to the precise forms disclosed, and obviously many modifications and variations are possible in light of the above teaching. The embodiments were chosen and described in order to best explain principles and practical applications thereof, and to thereby enable others skilled in the art to best utilize the various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims. The following claims are in no way intended to limit the scope of embodiments to the specific embodiments described herein.

What is claimed is:

1. An apparatus comprising:
at least one radio frequency identification (RFID) coupler embedded over a printed circuit board (PCB); and
at least one media sensor embedded over the PCB, wherein the at least one media sensor is configured to detect at least one media,
wherein the at least one RFID coupler having an eye-goggle shaped profile to accommodate the at least one media sensor such that the at least one RFID Coupler with the at least one media sensor are positioned in proximity to the at least one media.

2. The apparatus of claim 1, wherein the at least one media sensor is positioned within the at least one RFID coupler.

3. The apparatus of claim 2, wherein the at least one media sensor is center aligned to the at least one RFID coupler or the at least one RFID Coupler is center to the at least one Media sensor.

4. The apparatus of claim 1, wherein the at least one RFID coupler comprises a first end and a second end spaced apart from each other.

5. The apparatus of claim 4, wherein the at least one RFID coupler is fed with a radio frequency (RF) signal from the first end that splits into at least two paths and merges at the second end of the at least one RFID coupler.

6. The apparatus of claim 4, wherein the at least two paths of the RF signal correspond to a first path and a second path.

7. The apparatus of claim 4 further comprising at least one resistor coupled to the second end of the at least one RFID coupler.

8. The apparatus of claim 7, wherein the at least one resistor corresponds to at least a 50-ohm resistor.

9. The apparatus of claim 1, wherein the at least one media corresponds to at least one RFID media label.

10. The apparatus of claim 1, wherein the at least one RFID coupler is fabricated to have a length which is defined by frequency of operation.

11. A method comprising:
embedding at least one radio frequency identification (RFID) coupler over a printed circuit board (PCB); and
embedding at least one media sensor over the PCB, wherein the at least one media sensor is configured to detect at least one media,
wherein the at least one RFID coupler having an eye-goggle shaped profile to accommodate the at least one media sensor such that the at least one media sensor is positioned in proximity to the at least one media.

12. The method of claim 11, wherein the at least one media sensor is positioned within the least one RFID coupler.

13. The method of claim 12, wherein the at least one media sensor is center aligned to the at least one RFID coupler or the at least one RFID Coupler is center to the at least one Media sensor.

14. The method of claim 11, wherein the at least one RFID coupler comprises a first end and a second end spaced apart from each other.

15. The method of claim 14, wherein the at least one RFID coupler is fed with a radio frequency (RF) signal from the first end that splits into at least two paths and merges at the second end of the at least one RFID coupler.

16. The method of claim 14, wherein the at least two paths of the RF signal correspond to a first path and a second path.

17. The method of claim 14 further comprising at least one resistor coupled to the second end of the at least one RFID coupler.

18. The method of claim 17, wherein the at least one resistor corresponds to at least a 50-ohm resistor.

19. The method of claim 11, wherein the at least one media corresponds to at least one RFID media label.

20. The method of claim 11, wherein the at least one RFID coupler is fabricated to have a length which is defined by having frequency of operation.
